(19) United States
(12) Patent Application Publication
(10) Pub. No.: US 2014/0040133 A1
(43) Pub. Date: Feb. 6, 2014

(54) TEMPORARILY GRANTING PAYMENT AUTHORITY

(71) Applicant: KT Corporation, Seongnam (KR)

(72) Inventors: Min-Gu LEE, Seongnam-si (KR); Dong-Wan KIM, Seoul (KR); Ra-Woon CHOI, Seoul (KR)

(73) Assignee: KT Corporation, Seongnam (KR)

(21) Appl. No.: 13/955,286

(22) Filed: Jul. 31, 2013

(30) Foreign Application Priority Data
Jul. 31, 2012 (KR) 10-2012-0083987

(51) Int. Cl. G06Q 20/40

(52) U.S. Cl. CPC G06Q 20/40
USPC 705/44

(57) ABSTRACT

In at least one example embodiment, an end device includes an input unit configured to receive an input of information regarding an original payment source and an identifier of an authorized device; a transmitter configured to transmit, to a server, a request to grant temporary payment authority for the authorized device, the request including the information regarding the original payment source and the identifier for the authorized device; and a receiver configured to receive a notification that the temporary payment authority has been granted from the server.

### TECHNICAL FIELD

The embodiments described herein pertain generally to payment services by a temporarily authorized device.

### BACKGROUND

As mobile communication systems become ubiquitous, people can make payments by using an end device without having to hand over cash, a credit or debit card, or otherwise utilize banking services including automatic teller machines.

### SUMMARY

In one example embodiment, an end device includes an input unit configured to receive an input of information regarding an original payment source and an identifier of an authorized device; a transmitter configured to transmit, to a server, a request to grant temporary payment authority for the authorized device, the request including the information regarding the original payment source and the identifier for the authorized device; and a receiver configured to receive a notification that the temporary payment authority has been granted from the server.

In another example embodiment, a server includes a receiver configured to receive, from a first device, a request to grant temporary payment authority for a second device, the request including information regarding an original payment source and an identifier for the second device; an authenticator configured to determine whether the original payment source is available; a processor configured to grant and register the temporary payment authority in a database; and a transmitter configured to transmit a notification that the temporary payment authority has been granted to the first device.

In yet another example embodiment, there is a method performed by an end device that includes receiving input information regarding an original payment source and an identifier of an authorized device; transmitting, to a server, a request to grant temporary payment authority with respect to the authorized device, the request including the information regarding the original payment source and the identifier of the authorized device; and receiving, from the server, a notification that the temporary payment authority has been granted.

In yet another example embodiment, there is a method performed by a server that includes receiving, from a first device, a request to grant temporary payment authority for a second device, the request including an information on an original payment source and an identifier of the second device; determining whether the original payment source is available; generating the temporary payment authority; registering the generated temporary payment authority in a database; and transmitting, to the first device, a notification that the temporary payment authority has been granted.

In yet another example embodiment, a system includes a first device configured to receive an input of an information on an original payment source and a second device identifier and transmit a request to grant second device temporary payment authority, the request including the information regarding the original payment source and the second device identifier; and a server configured to receive, from the first device, the request to grant the second device temporary payment authority and determine whether the original payment source is available and grant the second device temporary payment authority and register the granted second device temporary payment authority in a database.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of a scheme to temporarily grant payment authority may be implemented;

FIG. 2 shows an example configuration of a first device by which at least portions of a scheme to temporarily grant payment authority may be implemented;

FIG. 3 shows an example configuration of a server by which at least portions of a temporarily authorized payment scheme may be implemented;

FIG. 4 shows an example processing flow of operations to implement at least portions of temporarily granting payment authority for a second device;

FIG. 5 shows an example processing flow of operations to implement at least portions of completing a payment;

FIG. 6 shows an example processing flow of at least some operations to temporarily grant payment authority;

FIG. 7 shows yet another example processing flow of at least some operations to temporarily grant payment authority;

FIG. 8 shows another example processing flow of at least some operations to temporarily grant payment authority;

FIG. 9 shows yet another example system configuration in which one or more embodiments of a scheme to temporarily grant payment authority may be implemented;

FIG. 10 shows still another example configuration of a first device by which at least portions of a scheme to temporarily grant payment authority may be implemented;

FIG. 11 shows an example configuration of a service request manager by which at least portions of a scheme to temporarily grant payment authority may be implemented;

FIG. 12 shows still another example configuration of a server by which at least portions of a scheme to temporarily grant payment authority may be implemented;

FIG. 13 shows an example configuration of a service providing manager by which at least portions of a scheme to temporarily grant payment authority may be implemented; and

FIG. 14 shows an illustrative computing embodiment, in which any of the processes and sub-processes of a scheme to temporarily grant payment authority may be implemented as computer-readable instructions stored on a computer-readable medium.

All of the above may be arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

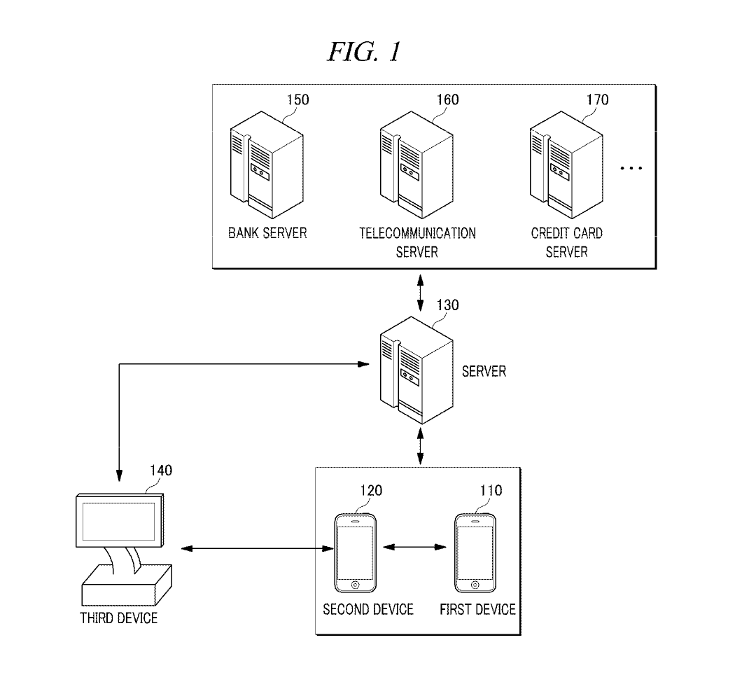

FIG. 1 shows an example system configuration in which one or more embodiments of a scheme to temporarily grant payment authority may be implemented, arranged in accordance with at least some embodiments described herein. As depicted in FIG. 1, the system configuration includes, at least, a first device 110, a second device 120, a server 130 corresponding to a service provider, a third device 140, one or more bank servers 150, one or more telecommunication servers 160, and one or more credit card servers 170; one or more of which may be connected to each other via a wireless network or a wired network.

As referenced herein, one or more bank servers 150 may be operated by a bank other similar financial institution. Similarly, one or more telecommunication servers 160 may be operated by a telecommunications service provider, and one or more credit card servers 170 may be operated by a credit card company, a bank, or other financial institution. Hereafter, one or more bank servers 150 may be referred as “bank server 150”, one or more telecommunication servers 160 may be referred as “telecommunication server 160”, and one or more credit card servers 170 may be referred as “credit card server 170,” without limiting such features in terms of quantity, unless context requires otherwise. The system configuration may not only include bank server 150, telecommunication server 160, and credit card server 170, but also further include other servers, operated by one or more other financial institutions corresponding to an original payment source input by a user of first device 110.

If the user of first device 110 wants a user of second device 120 to buy some goods with a credit card which the user of first device 110 possesses, the user of first device 110 may give the credit card to the user of second device 120. But, in this case, the user of second device may mis-use by using the credit card. Thus, to prevent the mis-use, the user of first device 110 may give to second device 120 authorization which granted to second device 120 by server 130, the user of second device 120 may buy the goods on behalf of the user of first device 110 by using the granted authorization.

Non-limiting examples of the original payment source may include a credit card account, a virtual account for an electronic wallet, a reward point account, a bank account, etc. Further, the original payment source may belong to the user of first device 110 or a corporation where the user of first device 110 works, and an amount as a price for the goods may be paid from the original payment source.

As depicted in FIG. 1, first device 110 may be configured to transmit, to server 130, a request to grant temporary payment authority for second device 120 to allow second device 120 to make a payment on behalf of first device 110. Here, the request may include information regarding an original payment source, such as credit card account, virtual account for electronic wallet, reward point account, bank account, etc.

The information regarding the original payment source may be utilized by server 130 to complete the payment after being input by a user to a user interface (UI) displayed on first device 110. The request may further include an identifier of second device 120, such as a telephone number or IP address, to inform server 130 of the identity of the device for which temporary payment authority is sought to be granted.

Further, first device 110 may receive a notification that the temporary payment authority has been granted from server 130. In some embodiments, first device 110 may receive the granted temporary payment authority. In this case, first device 110 may forward the notification and/or the received temporary payment authority to second device 120.

Second device 120 may be configured to receive the notification that the temporary payment authority has been granted thereto from server 130. Alternatively, second device 120 may receive the notification, or even confirmation thereof, from first device 110. In some embodiments, second device 120 may receive not only the notification but also the granted temporary payment authority from server 130.

Further, once granted the temporary payment authority, second device 120 may transmit the payment request to third device 140 to make the payment. In some embodiments, the payment request may include the received temporary payment authority.

First device 110 and second device 120 may respectively refer to at least one of a mobile phone, a smart phone, a portable device, a notebook, a personal computer or a personal communication terminal. Non-limiting examples of such devices may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals. Server 130, hosted by the service provider, may be configured to receive, from first device 110, the request to grant temporary payment authority to second device 120 on behalf of first device 110. Server 130 may grant the requested temporary payment authority, and transmit the corresponding notification to first device 110 and/or second device 120.

Server 130 may be configured to grant the temporary payment authority by collaborating with a corresponding financial institution. If the original payment source is a credit card, the granted temporary payment authority may include a new credit card number, the expiration date of the temporary payment authority (as a limited valid date), and the upper limit of the payment amount.

Server 130 may be further configured to receive the aforementioned payment request from third device 140, and to determine whether or not to accept the payment request. To determine whether or not to accept the payment request, server 130 may determine whether second device 120, from which the payment request originated, has been granted at least temporary authorization to facilitate the payment. Further, server 130 may determine whether or not the original payment source.

Server 130 may pay the amount due, included in the payment request, from the original payment source if second device 120 has been determined to have been granted at least temporary authorization to facilitate the payment. In accordance with at least some embodiments, to pay the payment, server 130 may collaborate with at least one of bank server 150, telecommunication server 160, and credit card server 170, at least one of which may be selected by server 130, based on the original payment source.

When the payment transaction has been successfully completed, server 130 may transmit a corresponding notification to at least one of first device 110, second device 120, and third device 140.

Third device 140, such as a point of sale (POS) terminal, etc., may be located at a place of commerce. Third device 140 may receive the payment request from a temporarily authorized second device 120 and forward the payment request to server 130. In accordance with at least some embodiments, the forwarded payment request may include the payment amount owed by the user of first device 110.

As set forth above, servers operated by financial institutions may include bank server 150, telecommunication server 160, credit card server 170, etc. For example, if the user of first device 110 sets the credit card account as the original payment source, credit card server 170 may receive a request to pay the payment amount from the credit card account.

Further, telecommunication server 160 may be configured to verify the user of first device 110, or the user of second device 120 in response to a request received from server 130.

In brief, server 130 may grant the temporary payment authority to second device 120, and transmit the granted temporary payment authority to second device 120. Further, to make the payments, second device 120 may transmit, to third device 140, the payment request including the temporary payment authority received from server 110. Subsequently, to complete the payments, third device 140 may transmit, to server 130, the payment request including the temporary payment authority received from second device 120.

Thus, FIG. 1 shows example system configuration in which a scheme to at least temporarily grant payment authority may be implemented.

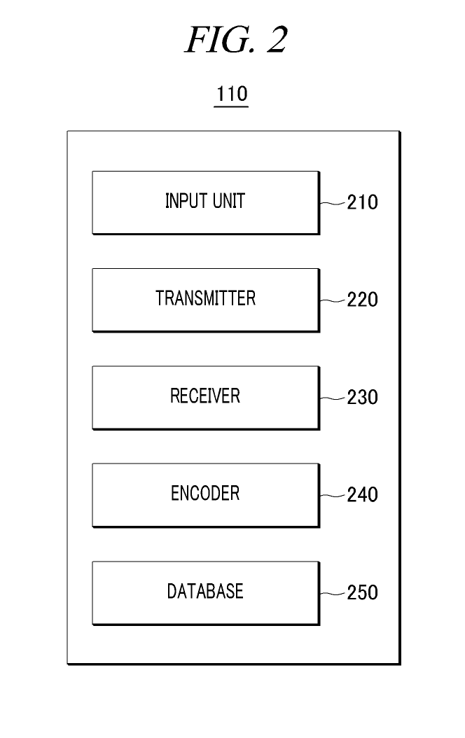

FIG. 2 shows an example configuration of first device 110 by which at least portions of a scheme to at least temporarily grant payment authority may be implemented. As depicted in FIG. 2, first device 110, which is described above with regard to FIG. 1, may include an input unit 210, a transmitter 220, a receiver 230, an encoder 240, and a database 250. Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of input unit 210, transmitter 220, receiver 230, encoder 240, and database 250 may be included in an instance of an application hosted by first device 110.

Input unit 210 may be configured to receive input information regarding an original payment source, such as a credit card account, a virtual account for an electronic wallet, a reward point account, a bank account, etc. The information regarding original payment source may be used by a server 130 to determine a financial institution corresponding to the original payment source.

Input unit 210 may be configured to further receive an input identifier for second device 120, such as a telephone number, to identify second device 120 as having been granted temporary payment authority.

A user of first device 110 may input the information regarding the original payment source and the identifier of second device 120 into certain input fields included in a UI displayed on first device 110.

Further, input unit 210 may receive an input of at least one payment condition with respect to the temporary payment authority. In accordance with some embodiments, the payment condition may include an upper limit of a payment amount, an allowed number of payments, an expiration date of the temporary payment authority, etc. The payment condition may further include a predefined usage, such as a utility fee, a health insurance premium, a category for goods, etc. The at least one payment condition may be transmitted to server 130 by transmitter 220.

Transmitter 220 may be configured to transmit, to server 130, a request to grant temporary payment authority to second device 120. In accordance with some embodiments, the request to grant temporary payment authority may include the information regarding the original payment source and the identifier of second device 120.

In some embodiments, transmitter 220 may transmit the request in response to a request received from second device 120. Thus, transmitter 220 may transmit, to server 130, the required payment amount, as the payment condition, by inserting the required payment amount into the request to grant temporary payment authority.

Receiver 230 may be configured to receive, from second device 120, a request to grant at least temporary payment authority to second device 120, which may include a required payment amount, in accordance with at least some embodiments.

Receiver 230 may be further configured to receive, from server 130, a notification that the temporary payment authority has been granted. In some embodiments, receiver 230 may receive the granted temporary payment authority. If the original payment source is credit card account, the granted temporary payment authority may include a new card number, the expiration date of the temporary payment authority (as a limited valid date), and the upper limit of the payment amount based on the at least one payment conditions. The temporary payment authority may be granted by server 130 by collaborating with the financial institution corresponding to the original payment source.

Further, when server 130 completes a payment, receiver 230 may be configured to receive, from server 130, a notification that the payment has been completed.

Receiver 230 may be even further configured to receive a security code from server 130 that may be utilized by other components of first device 110, e.g., encoder 240, to prevent mis-use of the granted temporary payment authority by a third person.

Encoder 240 may be configured to encode the received security code with information regarding first device 110 by using a cryptographic hash function. Further, the encoded security code may be transmitted to second device 120 by transmitter 220, via at least one way of radio frequency identification (RFID), near field communications (NFC), Bluetooth, or WiFi.

The cryptographic hash function, such as MD5, SHA-1, SHA-2, SHA-3, etc., may be designed to take a string of any length as input and produce a fixed-length hash value.

Database 250 may be configured to store data, including data input to or output from the components of first device 110. Non-limiting examples of such data may include the information of original payment source and the identifier of second device 120 which are input by input unit 210.

Further, by way of example, database 250 may be embodied by at least one of a hard disc drive, a ROM (Read Only Memory), a RAM (Random Access Memory), a flash memory, or a memory card as an internal memory or a detachable memory of first device 110.

Thus, FIG. 2 shows an example configuration of a first device 110 by which at least portions of a scheme to grant at least temporary payment authority may be implemented.

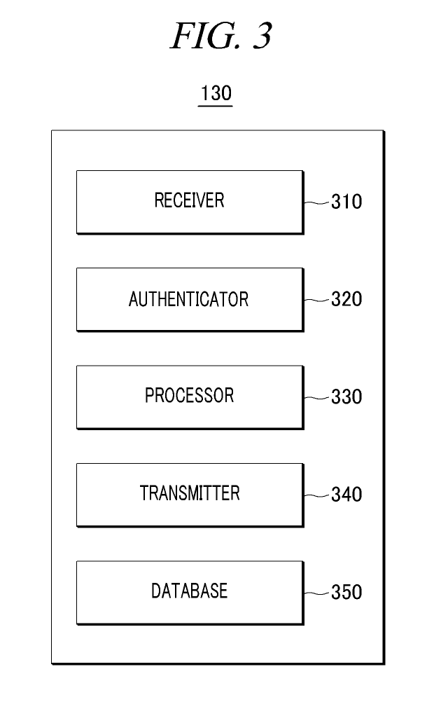

FIG. 3 shows an example configuration of a server 130 by which at least portions of a scheme to grant at least temporary payment authority may be implemented. As depicted in FIG. 3, server 130, which is described above with regard to FIG. 1, may include a receiver 310, an authenticator 320, a processor 330, a transmitter 340, and a database 350. Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of receiver 310, authenticator 320, processor 330, transmitter 340, and database 350 may be included in an instance of an application hosted by server 130.

Receiver 310 may be configured to receive, from first device 110, a request to grant temporary payment authority to second device 120, on behalf of a user of first device 110. The request to grant temporary payment authority may include information regarding an original payment source and an identifier for second device 120. Non-limiting examples of original payment source may include at least one of a credit card account, a virtual account for an electronic wallet, a reward point account, or a bank account. Further, the original payment source may belong to the user of first device 110 or a corporation where the user of first device 110 works, and an amount as a price for goods may be paid from the original payment source.

Receiver 310 may be configured to receive, from first device, information regarding first device 110 including a telephone number, a serial number, a Media Access Control (MAC) address, etc. The information regarding first device 110 may further include information pertaining to a user of first device 110, such as a name, an email address, an Internet Personal Identification Number (I-PIN), a social security number, a passport number, a driver's license number, etc. Such information may be utilized to verify the original payment source by authenticator 320.

Receiver 310 may be further configured to receive, from first device 110, at least one payment condition with respect to the requested temporary payment authority, including at least one of an upper limit of a payment amount, an allowed number of payments, or an expiration date of the temporary payment authority.

Further still, receiver 310 may be configured to receive, from a third device 140, a payment request to complete a payment, including a payment amount and notification of temporary payment authority granted to second device 120. The temporary payment authority may be circulated from server 130 to first device 110; first device 110 to second device 120; second device 120 to third device 140; and third device 140 to server 130. For example, server 130 may transmit the temporary payment authority to first device 110, and first device 110 may receive and transmit the temporary payment authority to second device 120, and second device 120 may receive and transmit the temporary payment authority to third device 140, and third device 140 may receive and transmit the temporary payment authority to server 130.

Authenticator 320 may be configured to determine whether or not the original payment source is valid. For example, authenticator 320 may determine whether or not a bank account is dormant, or whether a credit card has expired. Authenticator 320 may be further configured to determine whether the original payment source corresponds to the user of first device 110 by using the received information regarding first device 110. For example, if the original payment source is a credit card account, authenticator 320 may determine whether an owner of the credit card account is the user of first device 110.

Authenticator 320 may be further configured to determine whether an identifier corresponding to the received payment request is to the same as the identifier corresponding to the received request to grant temporary payment authority.

Authenticator 320 may be configured to determine whether the received payment request meets the at least one received payment condition, such as the upper limit of a payment amount, the allowed number of payments, the expiration date of the temporary payment authority, etc., to prevent exceeding the granted temporary payment authority for second device 120.

Further, authenticator 320 may be further configured to determine whether a security code included in the payment request is to the same as a security code stored in database 350. For example, both the security code included in the payment request and the security code stored in database 350, which are entities for the comparison, may be encoded by first device 110. Thus, receiver 310 may receive the encoded security code from first device 110; and processor 330 may register the encoded security code in database 350. Otherwise, both the security code included in the payment request and the security code stored in database 350 may be encoded by processor 330. Alternatively, the security code included in the payment request may be encoded by first device 110, and the security code stored in database 350 may be encoded by processor 330, independently.

Processor 330 may be configured to grant the temporary payment authority in response to the request received by receiver 310. Further, processor 330 may register the granted temporary payment authority in database 350.

Processor 330 may be further configured to match the received at least one payment condition with the registered temporary payment authority to inform authenticator 320 of the payment condition attached to the temporary payment authority.

Processor 330 may be even further configured to generate a security code for the registered temporary payment authority and to register the generated security code in database 350. The security code may be utilized for judging authenticity of the temporary payment authority included in the payment request. The generated security code may be transmitted to first device 110 by transmitter 340 to be described below.

Further, processor 330 may be configured to encode the generated security code by using information regarding first device 110 received by receiver 310, including a telephone number, a serial number, a Universal Subscriber Identity Module (USIM), an International Mobile Subscriber Identity (IMSI), a Globally Unique Temporary Identifier (GUTI), a Media Access Control (MAC) address, etc.

Processor 330 may be configured to seek a transaction entity (including a certain financial institution) by using the information regarding the original payment source. Processor 330 may be further configured to request to the transaction entity to pay the payment amount, to be paid for certain goods or services, from the original payment source to a bank account corresponding to third device 140.

Transmitter 340 may be configured to transmit, to first device 110 and/or second device 120, a notification that the requested temporary payment authority has been granted. In some embodiments, transmitter 340 may transmit the granted temporary payment authority with the notification. The transmitted temporary payment authority may include information regarding a newly generated payment source. For example, if the original payment source is credit card account, the temporary payment authority may include a new credit card number, the expiration date of the temporary payment authority (as a limited valid date), and the upper limit of the payment amount.

Further, when processor 330 completes the payment, transmitter 340 may be configured to transmit, to first device 110, a notification based on the temporary payment authority.

Transmitter 340 may be configured to further transmit, to first device 110, the generated security code or the encoded security code.

Database 350 may be configured to store data, including data input into each component and/or output data from each component included in first device 110. Non-limiting examples of stored data may include the information of original payment source received by receiver 310 and the security code generated by processor 330.

Further, by way of example, database 350 may include at least one of a hard disc drive, a ROM (Read Only Memory), a RAM (Random Access Memory), a flash memory, or a memory card as an internal memory or a detachable memory of first device 110.

Thus, FIG. 3 shows an example configuration of a server 130 by which at least portions of a scheme to grant at least temporary payment authority may be implemented.

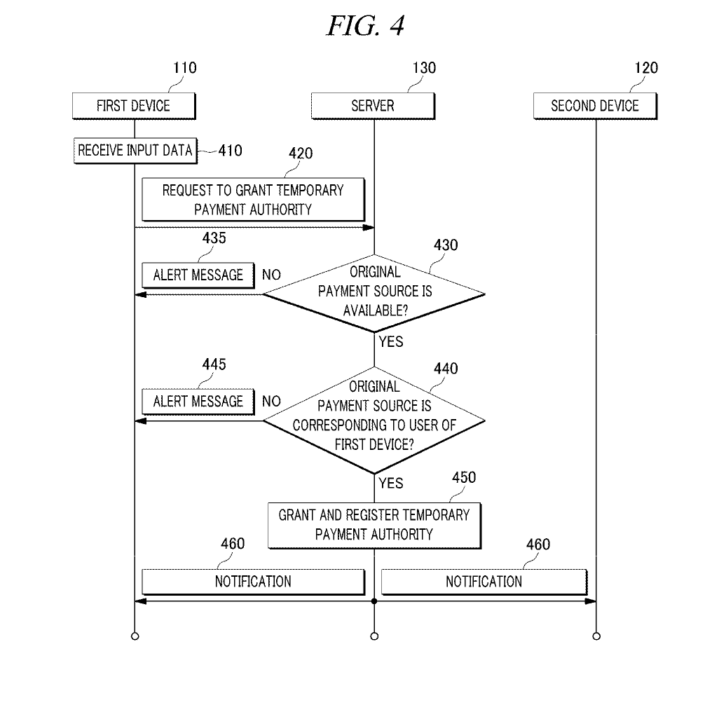

FIG. 4 shows an example processing flow of operations to implement at least portions of a scheme to grant temporary payment authority for second device 120. The process in FIG. 4 may be implemented in a system configuration including first device 110, second device 120, and server 130 of a service provider, as described with reference to FIG. 1. An example process may include one or more operations, actions, or functions as illustrated by one or more blocks 410, 420, 430, 435, 440, 445, 450 and/or 460. Although illustrated as discrete blocks, various blocks may be divided into additional blocks, combined into fewer blocks, or eliminated, depending on the desired implementation. Processing may begin at block 410.

Block 410 (Receive Input Data) may refer to first device 110 receiving input data from a user of first device 110, including an original payment source and an identifier of second device 120. Further, first device 110 may receive a user input corresponding to a request to grant temporary payment authority to second device 120 by clicking, selecting or otherwise activating a corresponding UI button displayed on a panel of first device 110. Processing may proceed from block 410 to block 420.

Block 420 (Transmit Request to Grant Temporary Payment Authority) may refer to first device 110 transmitting, to server 130, the request to grant temporary payment authority to second device 120. The request to grant temporary payment authority may include the received information regarding the original payment source and the received identifier of second device 120. In some embodiments, the request to grant temporary payment authority may further include at least one payment condition with respect to the temporary payment authority. Processing may proceed from block 420 to block 430.

Block 430 (Determine whether Original Payment Source is Available) may refer to server 130 determining whether or not the original payment source is valid. For example, server 130 may determine whether an account corresponding the original payment source is dormant or whether the account is currently valid by requesting confirmation from a corresponding financial institution. If the original payment source is not available, processing may proceed from block 430 to block 435; if the original payment source is available, processing may proceed from block 430 to block 440.

Block 435 (Transmit Alert Message) may refer to server 130 transmitting, to first device 110, a notification that the original payment source is not available as an alert. In this case, first device 110 may display the received notification, and provide the user of first device 110 a chance to input information regarding a new original payment source.

Block 440 (Determine whether Original Payment Source is corresponding to User of First Device) may refer to server 130 determining whether the original payment source corresponds to the user of first device 110. For example, server 130 may determine whether an owner of the account corresponding to the original payment source is to the same as the user of first device 110, or whether an owner of the account corresponding to the original payment source is to the same as a corresponding corporation to which the user of first device 110 belongs. If the original payment source does not correspond to the user of first device 110, processing may proceed from block 440 to block 445; if the original payment source does not correspond to the user of first device 110, processing may proceed from block 440 to block 450.

Block 445 (Transmit Alert Message) may refer to server 130 transmitting, to first device 110, an alert that the original payment source does not correspond to the user of first device 110. In this case, first device 110 may display the received notification, and provide the user of first device 110 a chance to input information regarding a new original payment source.

Block 450 (Grant and Register Temporary Payment Authority) may refer to server 130 granting the requested temporary payment authority and registering the granted temporary payment authority in a database of server 130. In some embodiments, server 130 may grant the temporary payment authority based on the at least one received payment condition. Processing may proceed from block 450 to block 460.

Block 460 (Transmit Notification indicating Completion of Grant) may refer to server 130 transmitting, to first device 110 and/or second device 120, a notification that the temporary payment authority has been granted and/or the granted temporary payment authority. In some embodiments, server 130 may transmit the notification (with the granted temporary payment authority) only to first device 110, and first device 110 may forward the received notification (with the granted temporary payment authority) to second device 120.

Thus, FIG. 4 shows an example processing flow of operations to implement at least portions of a scheme to grant at least temporary payment authority to a second device 120.

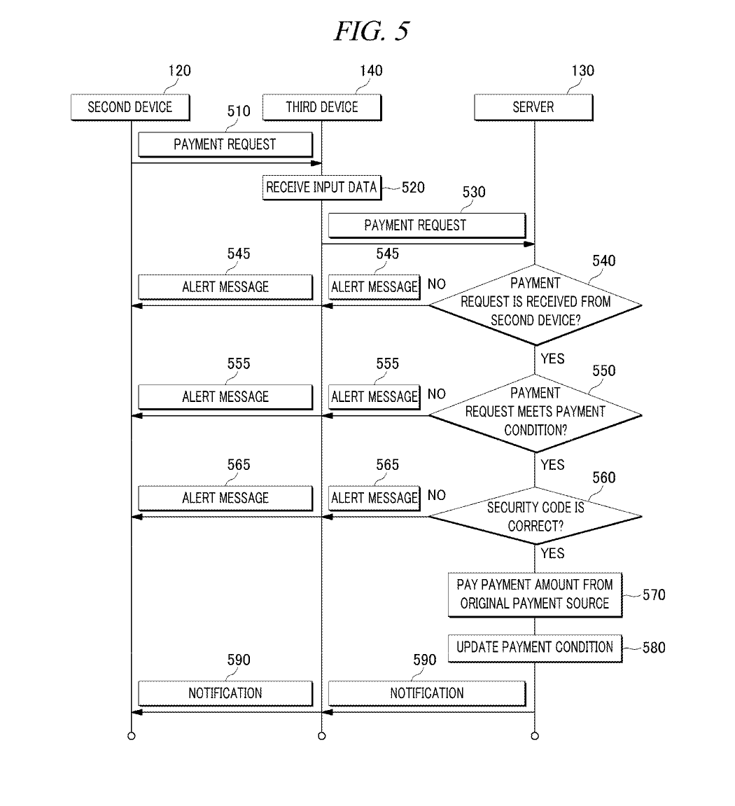

FIG. 5 shows an example processing flow of operations to implement at least portions of completing a payment, in accordance with at least some of the embodiments described herein. The process in FIG. 5 may be implemented in a system configuration including second device 120, server 130 of a service provider, and third device 140, as described with reference to FIG. 1. An example process may include one or more operations, actions, or functions as illustrated by one or more blocks 510, 520, 530, 540, 545, 550, 555, 560, 570, 580 and/or 590. Although illustrated as discrete blocks, various blocks may be divided into additional blocks, combined into fewer blocks, or eliminated, depending on the desired implementation. Processing may begin at block 510.

Block 510 (Transmit Payment Request) may refer to second device 120 transmitting, to third device 140, a payment request, including an identifier of second device 120 and a security code. The security code may be generated by server 130, and received from server 130. In some embodiments, the payment request may further include temporary payment authority. Processing may proceed from block 510 to block 520.

Block 520 (Receive Input Data) may refer to third device 140 receiving input data, such as an amount due for a transaction. The data may be input by a clerk or a cashier using an input device integrated in or coupled to third device 140. In some embodiments, the input data may be input by reading an electronic tag corresponding to the certain goods/services with a reader or scanner. Non-limiting examples of the electronic tag may include a barcode, a quick response (OR) code, a smart tag, a radio frequency identification (RFID) tag, a near field communication (NFC) tag, etc. By way of example, but not limitation, the reader integrated in or coupled to third device 140 may include an image sensor (for camera) to capture the electronic tag, a radio frequency identification reader, a near field communication reader, a barcode reader, a quick response code reader, etc. Processing may proceed from block 520 to block 530.

Block 530 (Transmit Payment Request) may refer to third device 140 transmitting, to server 130, the payment request with the received payment amount to make a payment. Processing may proceed from block 530 to block 540.

Block 540 (Determine whether Payment Request is Received from Second Device 120) may refer to server 130 determining whether the payment request is received from second device 120. For example, server 130 may compare the identifier of second device 120 included in the payment request with an identifier of second device 120 to which server 130 has granted temporary payment authority. If the payment request is not received from second device 120, processing may proceed from block 540 to block 545; if the payment request is received from second device 120, processing may proceed from block 540 to block 550.

Block 545 (Transmit Alert Message) may refer to server 130 transmitting, to second device 120 and/or third device 140, a notification that the payment request has not been received from second device 120. In this case, second device 120 and/or third device 140 may display the received notification.

Block 550 (Determine Payment Request Meets Payment Condition) may refer to server 130 determining whether the payment request meets at least one payment condition registered in the database of server 130. For example, if a payment condition is a maximum payment amount allowed, server 130 may compare the maximum amount allowed with the payment amount included in the payment request. If the payment request does not meet at least one payment condition, processing may proceed from block 550 to block 555; if the payment request meets at least one payment condition, processing may proceed from block 550 to block 560.

Block 555 (Transmit Alert Message) may refer to server 130 transmitting, to second device 120 and/or third device 140, a notification that the payment request does not meet at least one payment condition. In this case, second device 120 and/or third device 140 may display the received notification.

Block 560 (Determine whether Security Code is Correct) may refer to server 130 determining whether the security code included in the payment request is to the same as a security code registered in the database of server 130. Here, both the security codes may be encoded security codes by using a cryptographic hash function. If the security code included in the payment request is not correct, processing may proceed from block 560 to block 565; if the security code included in the payment request is correct, processing may proceed from block 560 to block 570.

Block 565 (Transmit Alert Message) may refer to server 130 transmitting, to second device 120 and/or third device 140, a notification that the security code included in the payment request is not correct. In this case, second device 120 and/or third device 140 may display the received notification.

Block 570 (Pay Payment Amount from Original Payment Source) may refer to server 130 facilitate transfer of the amount due from the original payment source, e.g., from an account corresponding to the original payment source to a bank account corresponding to the place of commerce. Processing may proceed from block 570 to block 580.

Block 580 (Update Payment Condition) may refer to server 130 updating the at least one payment condition. For example, if the payment condition includes an allowed number of payments, one time may be deducted from the allowed number of payments. Processing may proceed from block 580 to block 590.

Block 590 (Transmit Notification of Complete Payment) may refer to server 130 transmitting, to second device 120 and/or third device 140, a notification of complete payment based on the temporary payment authority. The notification may include an electronic receipt, and second device 120 and/or third device 140 may display the received electronic receipt on a panel of each device.

In FIG. 5, an execution sequence of block 540 to block 560 is not limited to the above description, but block 540 to block 560 may be executed in a different order. Further, similarly, block 590 may be executed first and then block 580 may be executed later.

Thus, FIG. 5 shows an example processing flow of operations to implement at least portions of completing a payment.

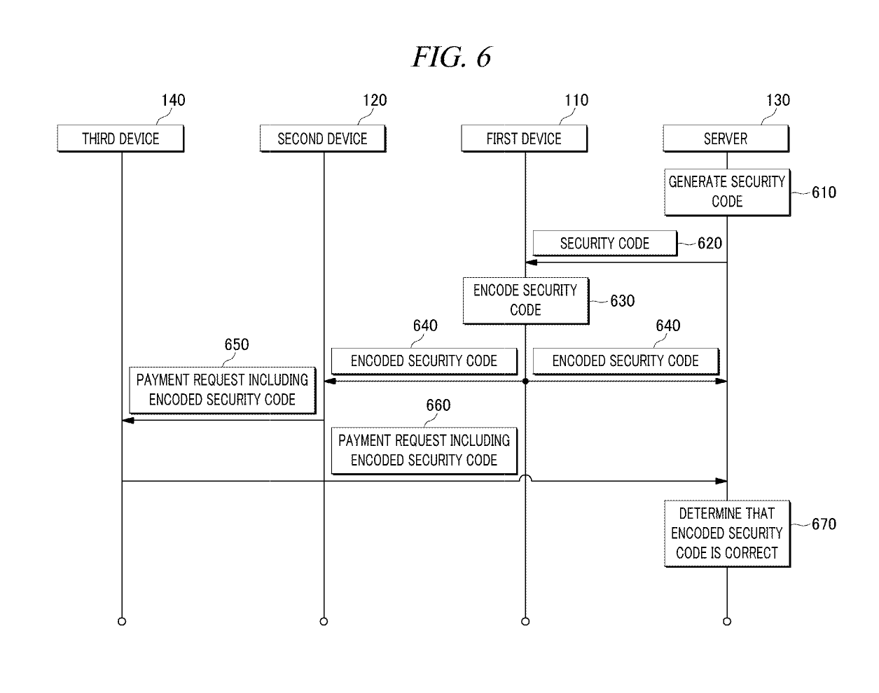

FIG. 6 shows an example processing flow of operations to implement at least portions of authenticating temporary payment authority. The process in FIG. 6 may be implemented in a system configuration including first device 110, second device 120, server 130 of a service provider, and third device 140, as described with reference to FIG. 1. An example process may include one or more operations, actions, or functions as illustrated by one or more blocks 610, 620, 630, 640, 650, 660 and/or 670. Although illustrated as discrete blocks, various blocks may be divided into additional blocks, combined into fewer blocks, or eliminated, depending on the desired implementation. Processing may begin at block 610.

Block 610 (Generate Security Code) may refer to server 130 generating a security code, and registering the generated security code matched with temporary payment authority. Here, the security code may be encoded with certain information, and the encoded security code may be utilized to prevent mis-use of the temporary payment authority. Processing may proceed from block 610 to block 620.

Block 620 (Transmit Security Code) may refer to server 130 transmitting the generated security code to first device 110. Processing may proceed from block 620 to block 630.

Block 630 (Encode Security Code) may refer to first device 110 encoding the received security code by, for example, using information regarding first device 110. Non-limiting examples of the information regarding first device 110 may include a telephone number, a serial number, a Universal Subscriber Identity Module (USIM), an International Mobile Subscriber Identity (IMSI), a Globally Unique Temporary Identifier (GUTI), a Media Access Control (MAC) address, etc. Further, first device 110 may encode the received security code by various methods, such as a cryptographic hash function. Processing may proceed from block 630 to block 640.

Block 640 (Transmit Encoded Security Code) may refer to first device 110 transmitting the encoded security code to second device 120 and server 130. Server 130 may receive the encoded security code, and register the received encoded security code in a database of server 130. Processing may proceed from block 640 to block 650.

Block 650 (Transmit Payment Request including Encoded Security Code) may refer to second device 120 transmitting, to third device 140, a payment request that includes an amount due for a transaction. The payment request may further include the encoded security code. Processing may proceed from block 650 to block 660.

Block 660 (Transmit Payment Request including Encoded Security Code) may refer to third device 140 transmitting, to server 130, the payment request including the encoded security code with the amount due. Processing may proceed from block 660 to block 670.

Block 670 (Determine that Encoded Security Code is Correct) may refer to server 130 determining that the encoded security code included in the received payment request is to the same as the encoded security code registered in the database.

Thus, FIG. 6 shows an example processing flow of operations to implement at least portions of authenticating temporary payment authority.

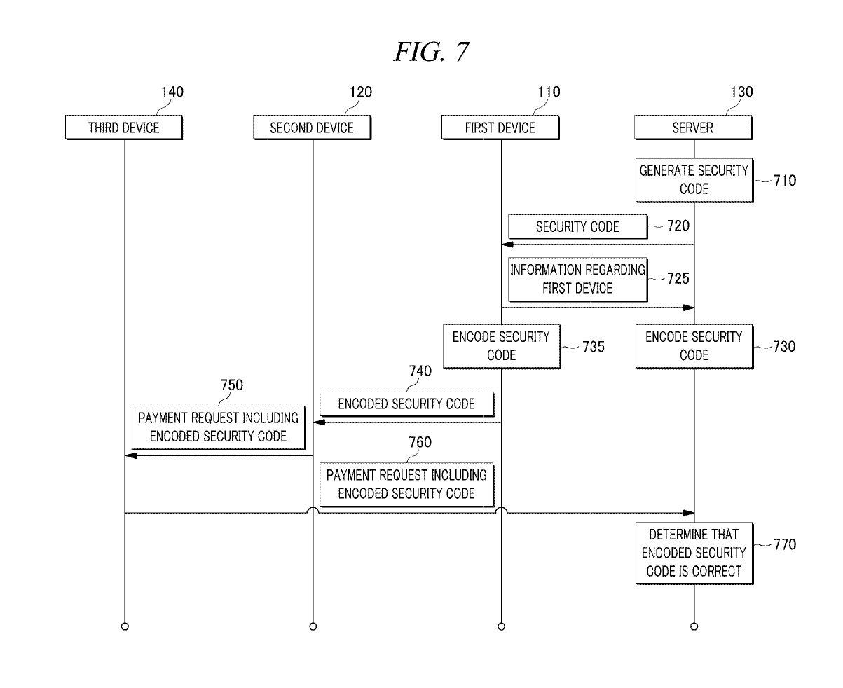

FIG. 7 shows yet another example processing flow of operations to implement at least portions of authenticating temporary payment authority. The process in FIG. 7 may be implemented in a system configuration including first device 110, second device 120, server 130 of a service provider, and third device 140, as described with reference to FIG. 1. An example process may include one or more operations, actions, or functions as illustrated by one or more blocks 710, 720, 725, 730, 735, 740, 750, 760 and/or 770. Although illustrated as discrete blocks, various blocks may be divided into additional blocks, combined into fewer blocks, or eliminated, depending on the desired implementation.

Since the function and operation of the blocks 710, 720, 740, 750, 760 and 770 are similar to those of the blocks 610, 620, 640, 650, 660 and 670 discussed above in FIG. 6, redundant description thereof will be omitted herein. Thus, the description may begin at block 725.

Block 725 (Transmit Information regarding First Device 110) may refer to first device 110 transmitting, to server 130, information regarding first device 110, including a telephone number, a serial number, a Universal Subscriber Identity Module (USIM), an International Mobile Subscriber Identity (IMSI), a Globally Unique Temporary Identifier (GUTI), a Media Access Control (MAC) address, etc. Processing may proceed from block 725 to block 730.

Block 730 (Encode Security Code) may refer to server 130 encoding a security code registered in a database of server 130 by using the received information regarding first device 110. Further, server 130 may select a certain method, for example a cryptographic hash function, among various security methods, such as a Symmetric-key algorithm, a Block cipher, a Stream cipher, a Public-key cryptography, a Cryptographic hash function, a Message authentication code, etc.

Server 130 may register the encoded security code matched with temporary payment authority in the database. Processing may proceed from block 730 to block 735.

Block 735 (Encode Security Code) may refer to first device 110 encoding the security code received from server 130 with the information regarding first device 110. In this case, first device 130 may select a certain method among the various security methods. But, first device 110 may select the same method which server 130 have selected.

Thus, FIG. 7 shows yet another example processing flow of operations to implement at least portions of authenticating temporary payment authority.

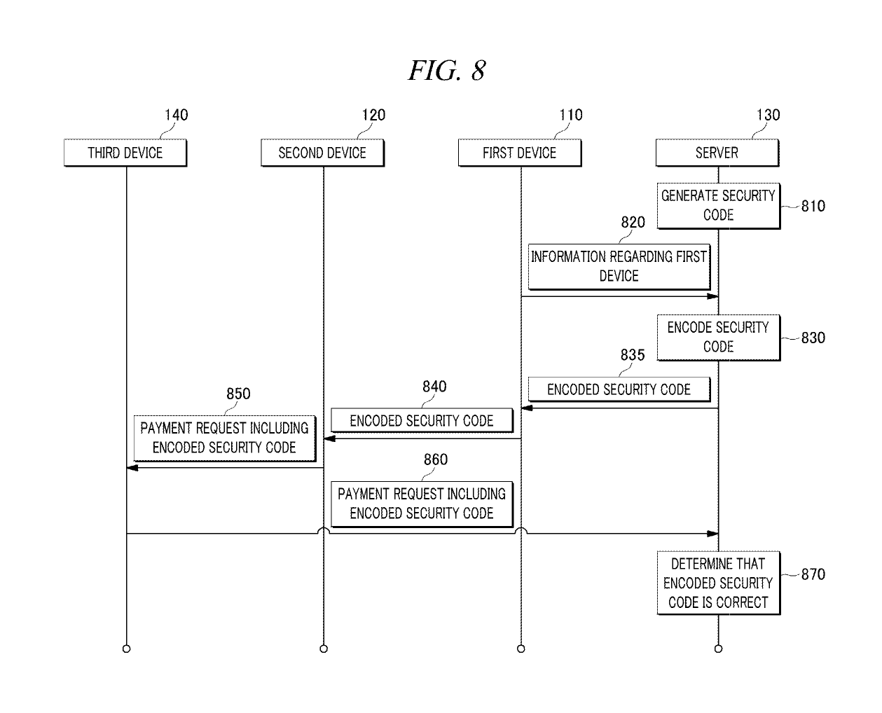

FIG. 8 shows yet another example processing flow of operations to implement at least portions of granting at least temporary payment authority. The process in FIG. 8 may be implemented in a system configuration including first device 110, second device 120, server 130 of a service provider, and third device 140, as described with reference to FIG. 1. An example process may include one or more operations, actions, or functions as illustrated by one or more blocks 810, 820, 830, 835, 840, 850, 860 and/or 870. Although illustrated as discrete blocks, various blocks may be divided into additional blocks, combined into fewer blocks, or eliminated, depending on the desired implementation.

Since the function and operation of the blocks 810, 840, 850, 860 and 870 are similar to those of the blocks 610, 640, 650, 660 and 670 discussed above in FIG. 6, redundant description thereof will be omitted herein. Thus, the description may begin at block 820.

Block 820 (Transmit Information regarding First Device 110) may refer to first device 110 transmitting, to server 130, information regarding first device 110, including a telephone number, a serial number, a Universal Subscriber Identity Module (USIM), an International Mobile Subscriber Identity PASO, a Globally Unique Temporary Identifier (GUTI), a Media Access Control (MAC) address, etc. Processing may proceed from block 820 to block 830.

Block 830 (Encode Security Code) may refer to server 130 encoding a security code registered in a database of server 130 by using the received information regarding first device 110. Further, server 130 may select a certain method, for example a cryptographic hash function, among various methods. Server 130 may register the encoded security code with respect to temporary payment authority in the database. Processing may proceed from block 830 to block 835.

Block 835 (Transmit Encoded Security Code) may refer to server 130 transmitting the encoded security code to first device 110.

Thus, FIG. 8 shows yet further example processing flow of operations to implement at least portions of authenticating temporary payment authority;

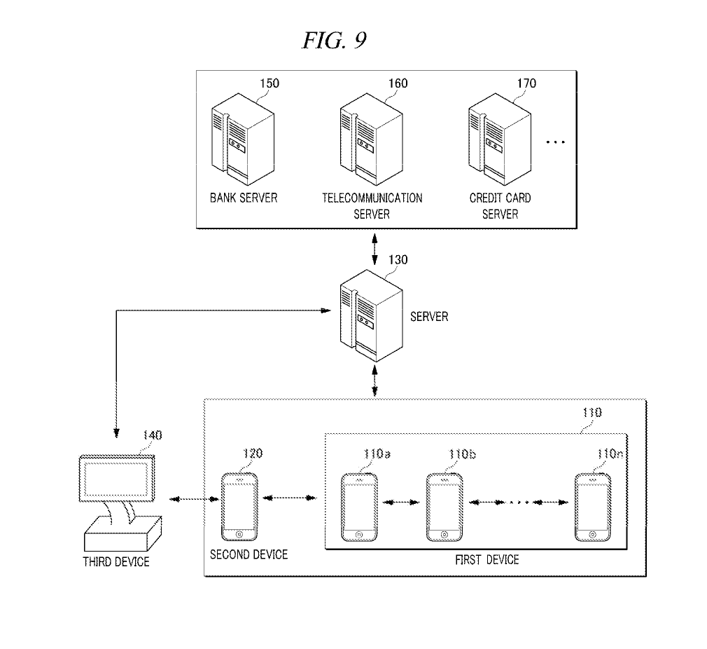

FIG. 9 shows yet another example system configuration in which one or more embodiments of temporary authority based payment may be implemented, arranged in accordance with at least some embodiments described herein. As depicted in FIG. 9, the system configuration includes, at least, multiple embodiments of first device 110, second device 120, server 130 of a service provider, third device 140, one or more bank servers 150, one or more telecommunication servers 160, and one or more credit card servers 170. Here, multiple embodiments of first device 110 may include first device 110a, 110b, . . . , 110n. Although three first devices are illustrated in FIG. 9, the number of first devices is not so limited.

At least one of first devices 110a, 110b, . . . , 110n, second device 120, server 130, third device 140, bank server 150, telecommunication server 160, and credit card server 170 may be connected to each other via a wireless network or a wired network.

When a user of second device 120 attempts to make a payment as a representative among users of first devices 110, the user of second device 120 may first pay for some goods, and then, ask the users of first devices 110a, 110b, . . . , 110n to pay for respective payment amounts due.

Otherwise, the user of second device 120 may first ask the users of first devices 110a, 110b, . . . , 110n to pay for respective payment amounts due what each user should pay, and then, pay for some goods. For example, each of first devices 110a, 110b, . . . , 110n may be configured to receive the respective payment amounts due from second device 120. Further, each of first devices 110a, 110b, . . . , 110n may transmit, to server 130, each request to grant temporary payment authority for second device 120 with each required payment amount received from second device 120.

Server 130 may be configured to receive each request to grant temporary payment authority to second device 120, and grant each temporary payment authority requested from each of first devices 110. In some embodiments, each granted temporary payment authority has an upper limit of a payment amount as much as received required payment amount. Alternatively, Server 130 may grant united temporary payment authority in response to each received request.

Thus, FIG. 9 shows yet another example system configuration in which one or more embodiments of temporary authority based payment may be implemented.

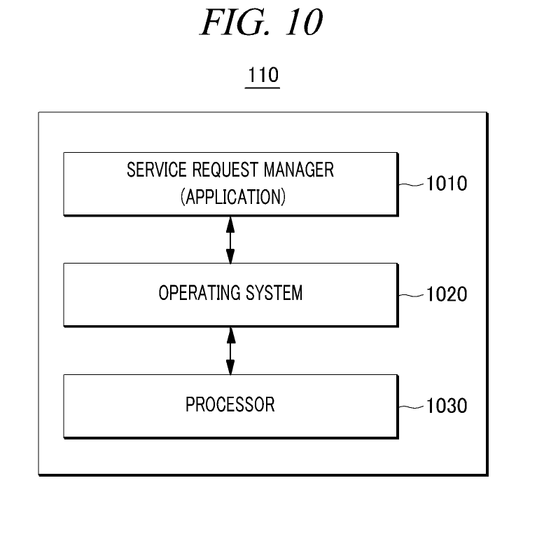

FIG. 10 shows still another example configuration of a first device 110 by which at least portions of a scheme to grant temporary payment authority may be implemented. As depicted in FIG. 10, first device 110, which is described above with regard to FIGS. 1-9, may include a service request manager 1010, an operating system 1020 and a processor 1030.

Service request manager 1010 may be an application configured to operate on operating system 1020 such that the temporary authority based payment schemes as described herein may be implemented.

Operating system 1020 may allow service request manager 1010 to manipulate processor 1030 to implement the temporary authority based payment schemes as described herein.

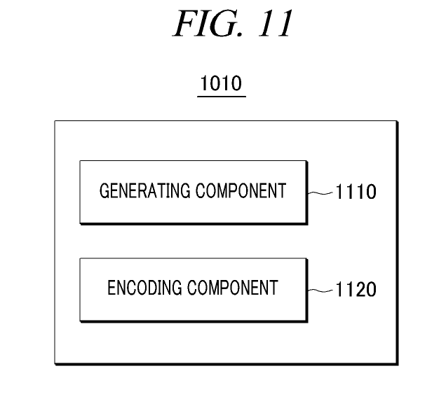

FIG. 11 shows an example configuration of a service request manager 1010 by which at least portions of a scheme to grant temporary payment authority may be implemented. As depicted, service request manager 1010 may include a generating component 1110 and an encoding component 1120.

Generating component 1110 may be configured to generate a request to grant temporary payment authority to second device 120 on behalf of first device 110. For example, generating component 1110 may generate the request based on a user input occurred by clicking, selecting or otherwise activating a corresponding UI (User Interface) button corresponding to the request displayed on a panel of first device 110.

Encoding component 1120 may be configured to encode a security code received from a server 130 to prevent mis-use of the granted temporary payment authority by a third person. In some embodiments, encoding component 1120 may encode the security code by using information regarding a first device 110 via a cryptographic hash function.

Thus, FIG. 10 shows still another example configuration of a first device 110 by which at least portions of temporary authority based payment may be implemented, and FIG. 11 shows an example configuration of a service request manager by which at least portions of temporary authority based payment may be implemented.

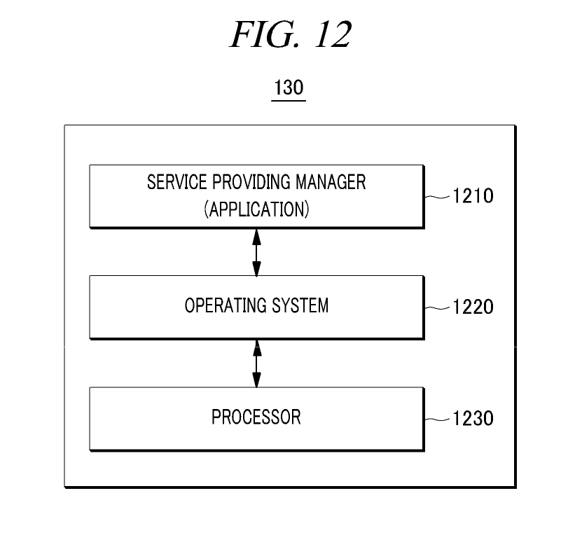

FIG. 12 shows still another example configuration of a server 130 by which at least portions of temporary authority based payment may be implemented. As depicted in FIG. 12, server 130, which is described above with regard to FIGS. 1-11, may include a service providing manager 1210, an operating system 1220 and a processor 1230.

Service providing manager 1210 may be an application configured to operate on operating system 1220 such that the temporary authority based payment schemes as described herein may be implemented.

Operating system 1220 may allow service providing manager 1210 to manipulate processor 1230 to implement temporary payment authority schemes as described herein.

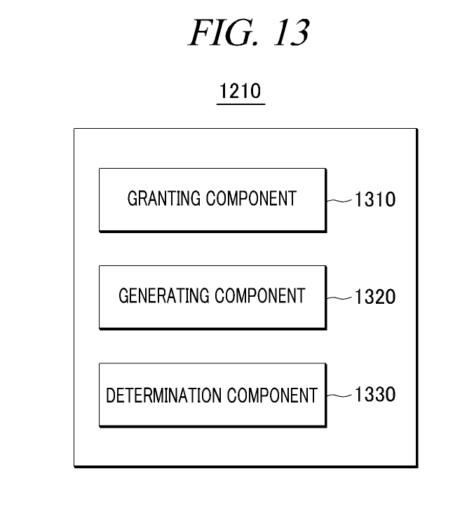

FIG. 13 shows an example configuration of a service providing manager by which at least portions of temporary authority based payment may be implemented. As depicted, service providing manager 1210 may include a granting component 1310, a generating component 1320 and a determination component 1330.

Granting component 1310 may be configured to grant temporary payment authority for a second device 120 in response to a request to grant the temporary payment authority received from a first device 110.

Generating component 1320 may be configured to generate a security code to prevent bad use of the temporary payment authority by a third person.

Determination component 1330 may be configured to determine various factors to grant the temporary payment authority. Non-limiting examples of the various factors to grant the temporary payment authority may include availability of original payment source, and possession of original payment source.

Further, determination component 1330 may determine various factors to pay a payment amount. Non-limiting examples of the various factors to pay the payment amount may include a payment request, a payment condition, security code.

Thus, FIG. 12 shows still another example configuration of a server by which at least portions of temporary authority based payment may be implemented, and FIG. 13 shows an example configuration of a service providing manager by which at least portions of temporary authority based payment may be implemented.

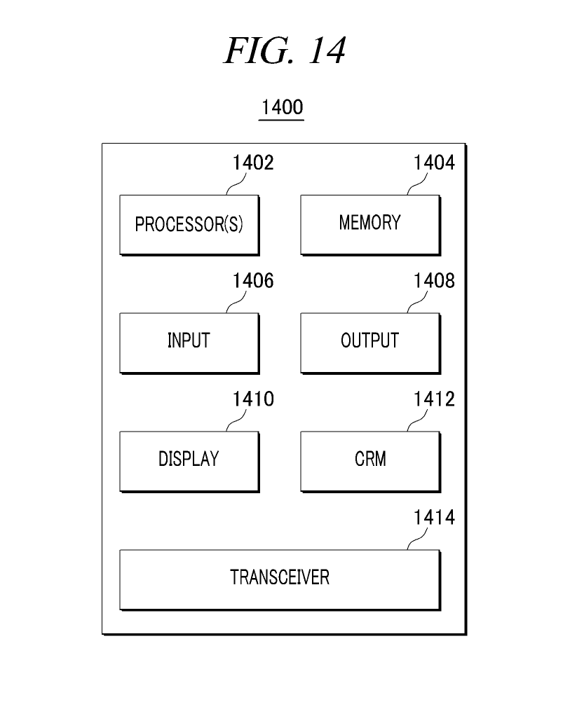

FIG. 14 shows an illustrative computing embodiment, in which any of the processes and sub-processes of temporary authority based payment may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for transactional permissions.

In a very basic configuration, a computing device 1400 may typically include, at least, one or more processors 1402, a system memory 1406, one or more input components 1406, one or more output components 1408, a display component 1410, a computer-readable medium 1412, and a transceiver 1414.

Processor 1402 may refer to, e.g., a microprocessor, a microcontroller, a digital signal processor, or any combination thereof.

Memory 1404 may refer to, e.g., a volatile memory, non-volatile memory, or any combination thereof. Memory 1404 may store, therein, an operating system, an application, and/or program data. That is, memory 1404 may store executable instructions to implement any of the functions or operations described above and, therefore, memory 1404 may be regarded as a computer-readable medium.

Input component 1406 may refer to a built-in or communicatively coupled keyboard, touch screen, or telecommunication device. Alternatively, input component 1406 may include a microphone that is configured, in cooperation with a voice-recognition program that may be stored in memory 1404, to receive voice commands from a user of computing device 1400. Further, input component 1406, if not built-in to computing device 1400, may be communicatively coupled thereto via short-range communication protocols including, but not limitation, radio frequency or Bluetooth.

Output component 1408 may refer to a component or module, built-in or removable from computing device 1400, that is configured to output commands and data to an external device.

Display component 1410 may refer to, e.g., a solid state display that may have touch input capabilities. That is, display component 1410 may include capabilities that may be shared with or replace those of input component 1406.

Computer-readable medium 1412 may refer to a separable machine readable medium that is configured to store one or more programs that embody any of the functions or operations described above. That is, computer-readable medium 1412, which may be received into or otherwise connected to a drive component of computing device 1400, may store executable instructions to implement any of the functions or operations described above. These instructions may be complimentary or otherwise independent of those stored by memory 1404.

Transceiver 1414 may refer to a network communication link for computing device 1400, configured as a wired network or direct-wired connection. Alternatively, transceiver 1414 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. An end device, comprising:
an input unit configured to receive an input of information regarding an original payment source and an identifier of an authorized device;
a transmitter configured to transmit, to a server, a request to grant temporary payment authority for the authorized device, the request including the information regarding the original payment source and the identifier for the authorized device; and
a receiver configured to receive a notification that the temporary payment authority has been granted from the server.

2. The end device of claim 1,
wherein the input unit is further configured to receive an input of at least one payment condition with respect to the temporary payment authority, and
wherein the transmitter is further configured to transmit, to the server, the at least one payment condition.

3. The end device of claim 2, wherein the at least one payment condition includes at least one of an upper limit of a payment amount, an allowed number of payments, or an expiration date of the temporary payment authority.

4. The end device of claim 1,
wherein the receiver is further configured to receive a security code from the server, and
wherein the end device further comprises an encoder configured to encode the security code, and
wherein the transmitter is further configured to transmit the encoded security code to the authorized device.

5. The end device of claim 4, wherein the encoder is further configured to encode the security code using a cryptographic hash function.

6. The end device of claim 1, wherein the receiver is further configured to receive a notification of complete payment based on the temporary payment authority from the server.

7. The end device of claim 1,
wherein the receiver is further configured to receive a required payment amount from the authorized device, and
wherein the request further includes the required payment amount.

8. The end device of claim 1, wherein the original payment source includes at least one of a credit card account, a virtual account for an electronic wallet, a reward point account, or a bank account.

9. A server, comprising:
a receiver configured to receive, from a first device, a request to grant temporary payment authority for a second device, the request including information regarding an original payment source and an identifier for the second device;
an authenticator configured to determine whether the original payment source is available;
a processor configured to grant and register the temporary payment authority in a database; and
a transmitter configured to transmit a notification that the temporary payment authority has been granted to the first device.

10. The server of claim 9, wherein the receiver is further configured to receive, from a third device, a payment request including a payment amount and the temporary payment authority, and
wherein the authenticator is further configured to determine whether an identifier included in the temporary payment authority is identical to the identifier included in the request, and
wherein the processor is further configured to request a transaction entity to pay the payment amount from the original payment source to a bank account corresponding to the third device.

11. The server of claim 10, wherein the receiver is further configured to receive, from the first device, at least one payment condition with respect to the temporary payment authority, and
wherein the processor is further configured to match the received at least one payment condition with the registered temporary payment authority.

12. The server of claim 11, wherein the authenticator is further configured to determine whether the payment request meets the at least one payment condition.

13. The server of claim 11, wherein the at least one payment condition includes at least one of an upper limit of a payment amount, an allowed number of payments, or an expiration date of the temporary payment authority.

14. The server of claim 10,
wherein the processor is further configured to generate and to register a security code for the registered temporary payment authority, and
wherein the payment request further includes a security code, and
wherein the determiner is further configured to determine whether the security code included in the payment request is identical to the registered security code.

15. The server of claim 14,
wherein the transmitter is further configured to transmit the generated security code to the first device, and
wherein the receiver is further configured to receive, from the first device, an encoded security code that is encrypted by the first device, and
wherein the authenticator is further configured to determine whether the security code included in the payment request is identical to the received encoded security code.

16. The server of claim 14,
wherein the receiver is further configured to receive information regarding the first device from the first device, and
wherein the processor is further configured to encode the generated security code by using the received information regarding the first device, and
wherein the determiner is further configured to determine whether the security code included in the payment request is identical to the encoded security code.

17. The server of claim 9,
wherein the receiver is further configured to receive an information on the first device from the first device, and
wherein the determiner is further configured to determine whether the original payment source corresponds to a user of the first device.

18. A method performed by an end device, comprising:
receiving input information regarding an original payment source and an identifier of an authorized device;
transmitting, to a server, a request to grant temporary payment authority with respect to the authorized device, the request including the information regarding the original payment source and the identifier of the authorized device; and
receiving, from the server, a notification that the temporary payment authority has been granted.

19. A method performed by a server, comprising:
receiving, from a first device, a request to grant temporary payment authority for a second device, the request including an information on an original payment source and an identifier of the second device;
determining whether the original payment source is available;
generating the temporary payment authority;
registering the generated temporary payment authority in a database; and
transmitting, to the first device, a notification that the temporary payment authority has been granted.

20. The method of claim 19, further comprising:
receiving, from a third device, a payment request including a payment amount and the temporary payment authority;
determining whether an identifier included in the temporary payment authority is identical to the identifier included in the request; and
paying the payment amount from the original payment source.

21. A system, comprising:
a first device configured to receive an input of an information on an original payment source and a second device identifier and transmit a request to grant second device temporary payment authority, the request including the information regarding the original payment source and the second device identifier; and
a server configured to receive, from the first device, the request to grant the second device temporary payment authority and determine whether the original payment source is available and grant the second device temporary payment authority and register the granted second device temporary payment authority in a database.

22. The system of claim 21, further comprising:
a second device configured to receive the second device temporary payment authority from the server, and transmit a payment request including the second device temporary payment authority; and
a third device configured to:
receive, from the second device, the payment request including the second device temporary payment authority, and
transmit the second device temporary payment authority and a payment amount to the server, and
wherein the server is further configured to:
receive, from the third device, the second device temporary payment authority and the payment amount, and
determine whether an identifier included in the second device temporary payment authority received from the third device is identical to the second device identifier included in the request, and
pay the payment amount from the original payment source to a bank account corresponding to the third device.
